(19) United States
(12) Patent Application Publication
(10) Pub. No.: US 2026/0077887 A1
(43) Pub. Date: Mar. 19, 2026

(54) Modular UAV Camera System And Related Methods

(71) Applicant: Skydio, Inc., San Mateo, CA (US)

(72) Inventor: Shantanu Mohta, Sunnyvale, CA (US)

(21) Appl. No.: 19/334,229

(22) Filed: Sep. 19, 2025

Related U.S. Application Data
(60) Provisional application No. 63/696,440, filed on Sep. 19, 2024.

(51) Int. Cl. B64U 20/87; B64C 39/02; B64D 47/08; B64U 20/83; B64U 101/30; G03B 3/10; G03B 17/14; H04N 23/55; H04N 23/90

(52) U.S. Cl. CPC B64U 20/87; B64C 39/024; B64D 47/08; B64U 20/83; G03B 3/10; G03B 17/14; H04N 23/55; H04N 23/90; B64U 2101/30

(57) ABSTRACT

Disclosed is a structural-electrical subsystem for an aircraft includes a fuselage and a one-piece guard forming a continuous perimeter frame with multiple rotor bays. It features modular side arm assemblies with a unitary body extending laterally from the fuselage, defining an open diamond-shaped geometry with motor mounts at opposed vertices. Internal wire conduits within the body route and protect electrical cables between the fuselage and motor mounts. The side arm assemblies, fuselage, and guard form a diamond-shaped reinforcement truss to distribute impact forces. Modular connectors couple the side arm assemblies to the fuselage and guard, allowing for easy assembly and maintenance. The system is designed for impact resilience and serviceability, with features like quick-release couplers and integrated electrical interfaces for power and data coupling.

### CROSS-REFERENCE TO RELATED APPLICATIONS

This application claims the benefit of U.S. Provisional Application No. 63/696,440, filed on Sep. 19, 2024, the contents of which are incorporated herein by reference in their entirety.

### TECHNICAL FIELD

The disclosure relates to a modular UAV camera system, and more particularly, to a UAV imaging system with interchangeable camera modules for enhanced imaging capabilities.

### BACKGROUND

Unmanned Aerial Vehicles (UAVs), commonly known as drones, have become increasingly prevalent in various industries due to their versatility and ability to access hard-to-reach areas. They are used in applications ranging from aerial photography and surveillance to agriculture and environmental monitoring. The demand for high-quality imaging systems on UAVs has grown significantly, as these systems are crucial for capturing detailed visual data that can be used for analysis, decision-making, and documentation. However, integrating advanced imaging systems into UAVs presents several challenges, including the need for lightweight, compact designs that do not compromise the UAV's flight performance.

Moreover, the dynamic environments in which UAVs operate require imaging systems that are robust and adaptable. Environmental factors such as dust, moisture, and varying light conditions can affect the performance of camera systems. Additionally, the need for different imaging capabilities, such as varying resolutions or spectral imaging, necessitates a flexible approach to camera system design. Traditional camera systems often require significant reconfiguration or recalibration when changing components, which can be time-consuming and impractical in field operations. Therefore, there is a growing need for modular camera systems that offer ease of interchangeability and adaptability to different imaging requirements while ensuring environmental protection and maintaining the integrity of the UAV's operation.

### SUMMARY

The techniques described herein discuss systems and methods for a modular unmanned aerial vehicle (UAV) camera system may include a gimbal assembly designed to hold one or more interchangeable camera modules. The system can feature several modular camera units that may be attached to the gimbal assembly using a standardized interface. Each modular camera unit can consist of multiple self-contained sub-components, such as an autofocus sub-component and a casing sub-component. These sub-components may adhere to uniform mechanical and electrical interfaces, allowing the modular camera units to be swapped on the gimbal assembly to offer various imaging capabilities.

Some examples of the modular UAV camera system may include additional self-contained sub-components within each modular camera unit, such as an optics sub-component and an imager sub-component. These components can also conform to the uniform mechanical and electrical interfaces.

In some implementations, the optics sub-component and the imager sub-component may differ among the modular camera units to provide diverse imaging capabilities.

In some implementations, the casing sub-component of the modular UAV camera system may be an environmentally sealed enclosure that offers protection against ingress for the self-contained sub-components.

In some implementations, the standardized interface of the modular UAV camera system can include a unified connector that provides both mechanical attachment and electrical coupling between the gimbal assembly and each modular camera unit.

In some implementations, the unified connector may carry power and data signals through a standardized pinout.

In some implementations, the modular camera units can be exchanged on the gimbal assembly without requiring reconfiguration or recalibration, enabling a plug-and-play operation.

In some implementations, the autofocus sub-component may include a micro-motor-driven focus mechanism with a motor and a translational drive.

In some implementations, the casing sub-component of each modular camera unit can have substantially identical dimensions and mounting features for attachment to the gimbal assembly.

In some implementations, the gimbal assembly may include multiple mounting interfaces to support several modular camera units simultaneously.

In some implementations, each modular camera unit can be designed to withstand mechanical vibrations and shock loads experienced during UAV flight.

In some implementations, a modular camera unit for a UAV gimbal assembly may include a casing sub-component with a standardized form factor and a gimbal interface for mechanical and electrical coupling. The autofocus sub-component can be mounted within the casing sub-component, along with additional sub-components like an optics sub-component and an imager sub-component. These components may be standardized across various modular camera units, and the optics and imager sub-components can be interchangeable to configure the modular camera unit for different imaging capabilities.

In some implementations, the casing sub-component may enclose and environmentally seal the autofocus sub-component and the additional sub-components.

In some implementations, the casing sub-component can include a standardized mounting footprint and attachment mechanism for connecting with the UAV gimbal assembly.

In some implementations, the gimbal interface may comprise a standardized multi-pin electrical connector for delivering power, control signals, and data between the modular camera unit and the UAV gimbal assembly.

In some implementations, the autofocus, optics, and imager sub-components can be individually removable and replaceable within the casing sub-component.

In some implementations, the imager sub-component may include an imaging sensor with a resolution of at least 12 megapixels.

In some implementations, the optics and imager sub-components can be interchangeable with other components having different optical properties or spectral wavebands.

In some implementations, the autofocus sub-component may feature a micro-motor-driven focus mechanism with a motor and a translational drive to adjust the focus of the optics sub-component.

In some implementations, the modular camera unit can be designed to withstand mechanical vibrations and shock loads up to 20 g during UAV flight without losing imaging performance or structural integrity.

Various other aspects, features, and advantages of the disclosed embodiments will be apparent through the detailed description and the drawings attached hereto. It is also to be understood that both the foregoing general description and the following detailed description are examples, and not restrictive of the scope of the invention. As used in the specification and in the claims, the singular forms of “a,” “an,” and “the” include plural referents unless the context clearly dictates otherwise. In addition, as used in the specification and the claims, the term “or” means “and/or” unless the context clearly dictates otherwise. Additionally, as used in the specification “a portion,” refers to a part of, or the entirety of (i.e., the entire portion), a given item (e.g., data) unless the context clearly dictates otherwise.

### BRIEF DESCRIPTION OF THE DRAWINGS

FIG. 1 illustrates a top perspective view of an example UAV having a gimbal system, consistent with various embodiments.

FIG. 2 illustrates a perspective view of an example gimbal system of a UAV, consistent with various embodiments.

FIG. 3 illustrates a side view of an example gimbal system of a UAV, consistent with various embodiments.

FIG. 4 illustrates a modular UAV camera system including a gimbal assembly 402 and modular camera units, consistent with various embodiments.

FIG. 5 is an exploded view of a standardized autofocus actuator sub-module, showing its key internal components including the stepper motor and lens carrier, consistent with various embodiments.

FIG. 6 is a diagram illustrating various embodiments of the modular UAV camera system, showing different gimbal assemblies and the interchangeable camera modules they support, consistent with various embodiments.

FIG. 7 is a block diagram of an example of a hardware configuration of a gimbal system of a UAV, consistent with various embodiments.

Embodiments will now be described in detail with reference to the drawings, which are provided as illustrative examples so as to enable those skilled in the art to practice the embodiments. Notably, the figures and examples below are not meant to limit the scope to a single embodiment, but other embodiments are possible by way of interchange of some or all of the described or illustrated elements. Wherever convenient, the same reference numbers will be used throughout the drawings to refer to same or like parts. Where certain elements of these embodiments can be partially or fully implemented using known components, only those portions of such known components that are necessary for an understanding of the embodiments will be described, and detailed descriptions of other portions of such known components will be omitted so as not to obscure the description of the embodiments. In the present specification, an embodiment showing a singular component should not be considered limiting; rather, the scope is intended to encompass other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the scope encompasses present and future known equivalents to the components referred to herein by way of illustration.

### DETAILED DESCRIPTION

Disclosed are embodiments providing a modular UAV camera system which may include a gimbal assembly designed to incorporate swappable camera modules, enhancing modularity and flexibility. The system may feature modular camera units that can interchangeably attach to the gimbal assembly via a standardized interface, allowing for easy swapping without reconfiguration or recalibration. Each camera unit may consist of self-contained sub-components, such as an autofocus sub-component with a micro-motor-driven focus mechanism, and a casing sub-component that provides ingress protection. The standardized interface may include a unified connector for mechanical attachment and electrical coupling, facilitating power and data transfer. The casing sub-component may have identical dimensions and mounting features, ensuring uniformity and ease of attachment. The gimbal assembly may support multiple camera configurations simultaneously, and the camera units may be designed to withstand mechanical vibrations and shock loads during UAV flight, ensuring durability and reliability. The system may offer versatility in imaging capabilities by allowing interchangeable optics and imager sub-components, with the imager sub-component potentially having a resolution of at least 12 megapixels for high-quality imaging.

The gimbal assembly may be configured to incorporate one or more swappable camera modules, allowing for modularity and flexibility in the UAV imaging system. The modular camera units may be configured to interchangeably attach to the gimbal assembly via a standardized interface, which may simplify operation and enhance usability. This configuration may enable the camera modules to be exchanged without reconfiguration or recalibration, thus allowing for plug-and-play operation. The first and second camera modules may be removably attached to the gimbal assembly via the mounting interface, which may support and attach the camera modules effectively. The gimbal assembly may comprise a mounting interface, which may enable easy swapping of camera modules without reconfiguration. The system may comprise a plurality of individually packaged sub-modules, including the lens sub-module, sensor sub-module, autofocus actuator sub-module, and housing sub-module, which may provide modularity and customization. The plug-and-play operation may be facilitated by the standardized mechanical and electrical interfaces, which may ensure compatibility and interchangeability across the system. The autofocus actuator sub-module may comprise a micro-motor-driven focus mechanism, including a motor and a translational drive, which may adjust the focus of the lens sub-module precisely. The housing sub-module may have identical dimensions and mounting features, ensuring consistent form-factor and attachment to the gimbal assembly. The UAV imaging system may be configured to withstand mechanical vibrations and shock loads experienced during UAV flight, maintaining imaging performance and structural integrity. The modular camera units may be interchangeable to configure the system for different imaging capabilities, providing versatility in imaging. The imager sub-component may comprise an imaging sensor having a resolution of at least 12 megapixels, ensuring high-quality imaging. The unified connector interface may provide both mechanical attachment and electrical coupling, facilitating power and data transfer between the gimbal and the camera modules. The system may include multiple mounting interfaces configured to support a plurality of camera modules simultaneously, allowing multiple camera modules to be used at once. The housing sub-module may be an environmentally sealed enclosure meeting at least an IP54 ingress protection rating, protecting internal components from dust and water spray.

The optics sub-component, imager sub-component, casing sub-component, autofocus sub-component, standardized mechanical and electrical interfaces, autofocus actuator sub-module, and housing sub-module may conform to uniform mechanical and electrical interfaces. This conformance may ensure compatibility and standardization across the system. The optics sub-component and imager sub-component may be interchangeable to configure the modular camera unit for different imaging capabilities. This interchangeability may provide versatility in imaging and may allow for modularity and customization. The autofocus sub-component may comprise a micro-motor-driven focus mechanism, including a motor and a translational drive, which may enable precise focusing. The autofocus actuator sub-module may adjust the focus of the lens sub-module, potentially enhancing the imaging capabilities of the system. The casing sub-component may have substantially identical dimensions and mounting features, which may ensure uniformity and ease of attachment. The outer housing sub-modules of the first and second camera modules may have identical dimensions and mounting features, which may ensure a consistent form-factor and attachment to the gimbal assembly. The standardized mechanical and electrical interfaces may facilitate the seamless integration of various sub-components, potentially enhancing the system's adaptability and functionality. The housing sub-module may provide a standardized form factor, which may contribute to the system's modularity and ease of use. The potential for interchangeability and standardization may allow for a wide range of imaging configurations, potentially expanding the system's applicability in various UAV operations.

The casing sub-component may be designed to provide ingress protection, potentially serving as an environmentally sealed enclosure that meets at least an IP54 ingress protection rating. This configuration may protect internal components from environmental factors, such as dust and water spray. The housing sub-module may incorporate gaskets or seals to provide environmental resistance equivalent to an IP54 rating, thereby safeguarding the autofocus, lens, and sensor sub-modules from dust and moisture. The environmentally sealed enclosure may be constructed to ensure that the internal components are shielded from external environmental conditions, which may enhance the durability and reliability of the system. The ingress protection may be achieved through the use of standardized mechanical and electrical interfaces, which may ensure compatibility and interchangeability across different modular camera units. The standardized interfaces may facilitate the seamless integration of various sub-components, allowing for the modular camera units to be exchanged on the gimbal assembly without compromising the protection of the internal components. The potential for environmental protection may be a significant aspect of the system, as it may enable the modular camera units to maintain their functionality and performance in diverse operating conditions.

The standardized interface may include a unified connector that provides both mechanical attachment and electrical coupling. This unified connector may facilitate the connection and communication between the gimbal assembly and the modular camera units. The standardized multi-pin electrical connector may be used to deliver power, control signals, and data, ensuring compatibility and standardization across different camera modules. The unified connector interface may be designed to facilitate power and data transfer, allowing for seamless integration of the camera modules with the gimbal assembly. The mechanical attachment and electrical coupling provided by the unified connector may enable the modular camera units to be easily attached and detached from the gimbal assembly, supporting modularity and flexibility in the UAV imaging system. The standardized pinout of the connector may ensure that the power and data signals are transmitted efficiently, enhancing the overall functionality of the system. The use of a standardized interface may simplify the operation and enhance the usability of the modular UAV camera system, allowing for easy swapping of camera modules without the need for reconfiguration or recalibration. This approach may provide a plug-and-play operation, enabling the camera modules to be interchanged on the gimbal assembly to provide different imaging capabilities. The unified connector may be a significant component in achieving the modularity and customization of the UAV camera system, allowing for the interchangeable use of camera modules to meet various imaging requirements.

The autofocus sub-component may comprise a micro-motor-driven focus mechanism, which may include a motor and a translational drive. This configuration may enable precise focusing capabilities. The micro-motor-driven focus mechanism may be designed to adjust the focus of the lens sub-module, potentially enhancing the imaging capabilities of the modular camera unit. The autofocus actuator sub-module may be integrated within the modular camera unit, allowing for seamless operation and compatibility with other sub-modules. The standardized mechanical and electrical interfaces may ensure that the autofocus sub-component can be easily interchanged or replaced within the modular camera unit, providing flexibility and customization options for different imaging requirements. The modular design may allow for the autofocus sub-component to be reused across various camera modules, maintaining consistency and reducing the need for additional components. The integration of the autofocus sub-component within the modular camera unit may contribute to the overall functionality and performance of the UAV camera system, potentially improving the quality and precision of captured images.

According to an embodiment, the casing sub-component may be designed to have substantially identical dimensions and mounting features, ensuring uniformity and ease of attachment. This may allow the first camera module and the second camera module to have identical dimensions and mounting features, which may ensure consistent form-factor and attachment. The outer housing sub-modules of the first and second camera modules may be configured to present the same form-factor and attachment points to the gimbal assembly. This may facilitate the process of attaching or detaching the camera modules from the gimbal assembly, potentially enhancing the modularity and flexibility of the UAV camera system. The standardized dimensions and mounting features may also contribute to the system's ability to support and attach camera modules without requiring reconfiguration or recalibration, thereby enabling plug-and-play operation. The uniformity in design may further simplify the operation and enhance the usability of the UAV camera system, allowing for easy swapping of camera modules to provide different imaging capabilities.

The gimbal assembly may include multiple mounting interfaces, which can be configured to support a plurality of camera modules simultaneously. This configuration may allow multiple camera modules to be used at once, thereby supporting multiple camera configurations. The gimbal assembly may be designed to accommodate various modular camera units, each potentially offering different imaging capabilities. The mounting interfaces may be standardized to ensure compatibility and ease of attachment for the camera modules. The camera modules may be constructed from standardized sub-modules, which can present the same attachment interface to the gimbal. This standardization may facilitate the interchangeability of camera modules, allowing for a seamless transition between different imaging setups. The gimbal assembly's ability to support multiple camera modules simultaneously may enhance the versatility and functionality of the UAV imaging system, potentially enabling a broader range of imaging applications.

The modular camera unit may be configured to withstand mechanical vibrations and shock loads experienced during UAV flight. This configuration may ensure durability and reliability, maintaining imaging performance and structural integrity. The camera module may be designed to endure shock loads up to 20 g, which may be significant for UAV operations. The vibration and shock resistance may be achieved through the integration of robust materials and design principles that can absorb and dissipate energy effectively. The camera module may incorporate a housing sub-module that provides a protective enclosure for the internal components, potentially enhancing the system's resilience against mechanical stresses. The housing sub-module may be constructed to meet specific standards, such as an IP54 ingress protection rating, which may offer additional protection against environmental factors like dust and water spray. The modular design of the camera unit may allow for the interchangeability of sub-components, such as the autofocus actuator sub-module, lens sub-module, and sensor sub-module, which may contribute to the system's versatility and adaptability to different imaging requirements. The standardized mechanical and electrical interfaces may facilitate the seamless integration of these sub-components, ensuring compatibility and interchangeability across different camera modules. This modular approach may enable the camera unit to be easily upgraded or reconfigured to meet evolving operational needs without compromising its structural integrity or performance.

In some implementations, the optics sub-component, imager sub-component, lens sub-module, second camera module, first camera module, sensor sub-module, autofocus actuator sub-module, different resolutions or wavebands, and housing sub-module of the modular UAV camera system may be interchangeable to configure the modular camera unit for different imaging capabilities. This interchangeability may provide versatility in imaging, allowing the system to adapt to or be constructed quickly to meet various imaging requirements. The modular camera unit may comprise a plurality of individually packaged sub-modules, which may include the lens sub-module, sensor sub-module, and autofocus actuator sub-module. These sub-modules may be interchangeable with other sensor sub-modules of different resolutions or wavebands, potentially providing modularity and customization. The housing sub-module may serve as an environmentally sealed enclosure, meeting at least an IP54 ingress protection rating, to protect the internal components from dust and water spray. The standardized mechanical and electrical interfaces may ensure compatibility and interchangeability across the different sub-modules, facilitating the easy swapping of camera modules without reconfiguration. The autofocus actuator sub-module may comprise a micro-motor-driven focus mechanism, including a motor and a translational drive, which may adjust the focus of the lens sub-module. This focus mechanism may enable precise focusing, enhancing the imaging capabilities of the system. The modular camera unit may be configured to withstand mechanical vibrations and shock experienced during UAV flight, including shock loads up to 20 g, without loss of imaging performance or structural integrity. This durability may ensure the reliability of the system in various operational conditions. The gimbal assembly may include multiple mounting interfaces configured to support a plurality of camera modules simultaneously, allowing multiple camera modules to be used at once. This capability may support multiple camera configurations, providing further versatility in imaging. The unified connector interface may provide both mechanical attachment and electrical coupling, facilitating power and data transfer between the gimbal and the camera module. This standardized interface may include a multi-pin electrical connector, delivering power, control signals, and data, ensuring seamless communication and operation of the system.

In some implementations, the imager sub-component may be integral to the modular UAV camera system, potentially comprising an imaging sensor with a resolution of at least 12 megapixels. This configuration may ensure high-quality imaging, allowing the capture of high-resolution images. The imager sub-component may be designed to conform to uniform mechanical and electrical interfaces, ensuring compatibility and standardization across the system. This standardization may facilitate the interchangeability of the imager sub-component with other components, potentially providing versatility in imaging capabilities. The imager sub-component may be interchangeable with other sensor sub-modules of different resolutions or wavebands, allowing the modular camera unit to be configured for different imaging capabilities. This interchangeability may be achieved without the need for reconfiguration or recalibration, enabling a plug-and-play operation. The imager sub-component may be housed within a casing sub-component that provides ingress protection, potentially meeting an IP54 ingress protection rating. This environmental sealing may protect the imager sub-component from dust and water spray, ensuring durability and reliability during UAV flight. The imager sub-component may be part of a modular camera unit configured to withstand mechanical vibrations and shock loads experienced during UAV flight, maintaining imaging performance and structural integrity. The modular camera unit may be attached to a gimbal assembly via a standardized interface, which may include a unified connector providing both mechanical attachment and electrical coupling. This interface may facilitate the delivery of power, control signals, and data between the gimbal assembly and the modular camera unit, ensuring seamless operation. The gimbal assembly may include multiple mounting interfaces, allowing the simultaneous support of multiple modular camera units, thereby enhancing the system's flexibility and adaptability.

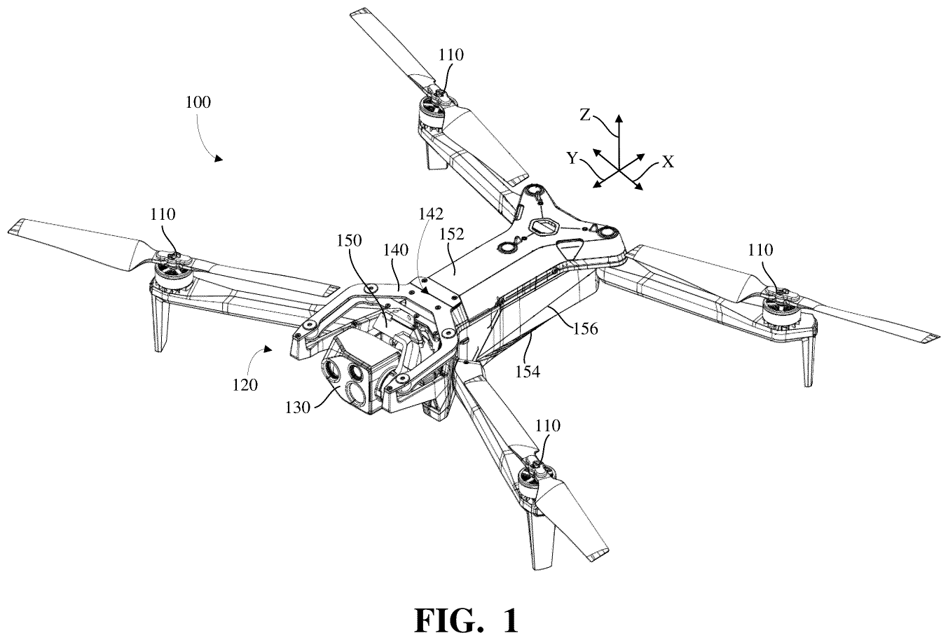

Turning now to the figures, FIG. 1 illustrates a perspective view of an unmanned aerial vehicle (UAV) 100. The UAV 100 may include one or more propulsion mechanisms (systems) 110 and a power source, such as a battery. The UAV 100 may be configured for autonomous flight, landing (e.g., docking) on a docking station, or both. To support the autonomous flight and landing, the UAV 100 may follow any suitable process or procedure and may include any suitable electrical and/or logical components. For example, the UAV 100 may follow processes or procedures, or may include one or more components, such as those described in U.S. Publication Ser. No. 16/991,122, the entire disclosure of which is herein incorporated by reference.

The propulsion mechanism(s) 110 may include any components and/or structures suitable for supporting flight of the UAV 100. For example, as shown in FIG. 1, the propulsion mechanism(s) 110 may be propeller assemblies having one or more blades connected to hubs of the UAV 100. The one or more blades may be powered by a motor to rotate the one or more blades and facilitate flight of the UAV 100. It should be appreciated, however, that the configuration and/or structure of the UAV 100 may vary depending on the particular UAV, and as such, the UAV 100 shown in FIG. 1 is not intended to limit the structure of the UAV 100.

The UAV 100 may also include one or more attachments coupled to the UAV 100. For example, as shown in FIG. 1, a gimbal system 120 may be coupled to the UAV 100. A frame 140 of the gimbal system 120 may be secured to the UAV 100 so that an image capture device 130 of the gimbal system 120 may be movably coupled to the UAV 100. That is, the gimbal system 120 may include a gimbal 150 that is configured to move the image capture device 130 in one or more degrees of motion. As a result, the gimbal 150 may be operable to capture images and/or videos during flight of the UAV 100, prior to flight of the UAV 100, after flight of the UAV 100, or a combination thereof. That is, the gimbal system 120 may be operable in conjunction with flight of the UAV 100 or the gimbal system 120 may be operable independently of flight of the UAV 100.

The gimbal system 120 may be coupled to various portions of the UAV 100. For example, the gimbal system 120 may be coupled to a front portion of the UAV 100 such that the gimbal system 120 is located in front of a body of the UAV 100 with respect to a longitudinal axis (Y) of the UAV 100. That is, the longitudinal axis (Y) may be a fore-aft direction of travel (e.g., forwards and backwards) such that the gimbal system 120 may be located in front of the UAV 100 when the UAV 100 travels forward.

While the gimbal system 120 shown in FIG. 1 is coupled to the front portion of the UAV 100, it should be noted that attachment of the gimbal system 120 to the UAV 100 is not particularly limited to any one location of the UAV 100. For example, the gimbal system 120 may be mounted to a side of the UAV 100 such that the gimbal system 120 is positioned in front of the UAV 100 when the UAV 100 travels in a lateral direction along a transverse a lateral axis (X) of the UAV 100 and/or the gimbal system 120 may be mounted to a top or bottom of the UAV 100 such that the gimbal system 120 is positioned in front of the UAV 100 when the UAV 100 travels in an elevational direction along an elevational axis (Z) of the UAV 100. Thus, the gimbal system 120 may be coupled to a rear, top, bottom, front, or side of the UAV 100 depending on a desired configuration. However, it is envisioned that the gimbal system 120 may advantageously couple to the UAV 100 in a manner that does not obstruct the propulsion mechanism(s) 110 of the UAV 100 to allow for movement of the UAV 100 in the longitudinal direction (e.g., along the longitudinal axis (Y)), in the lateral direction (e.g., along the lateral axis (X)), and in the elevational direction (e.g., along the elevational axis (Z)).

As discussed above, the frame 140 of the gimbal system 120 may be coupled to the UAV 100 to movably couple the image capture device 130 to the UAV 100 (e.g., a body of the UAV 100). The frame may abut one or more surfaces of the UAV 100 such that the frame may be coupled to the one or more surfaces of the UAV 100. For example, the frame 140 may extend along an upper, planar surface of the UAV 100. The upper, planar surface may be a top surface 152 of the UAV 100 based upon the elevational axis (Z). A surface of the frame 140 may be flush or otherwise complementary in shape to the top surface 152 of the UAV 100 such that, when the frame 140 is coupled to the UAV 100 (e.g., via one or more fasteners), all or a portion of the frame 140 may be supported by the top surface 152 of the UAV 100. For example, the frame 140 may include a planar portion 142 that extends along or parallel to the longitudinal axis (X) of the UAV 100. The planar portion 142 of the frame 140 may be supported by and coupled to the top surface 152 of the UAV 100. The top surface 152 may be planar such that the planar portion 142 of the frame 140 is substantially or entirely supported by the top surface 152 of the UAV 100.

In certain configurations, the top surface 152 of UAV 100 may include one or more nonplanar portions, which may abut complementary nonplanar portions of the frame 140. Additionally, it should be noted that the frame 140 may also be coupled to an opposing bottom surface 154 of the UAV 100 and/or a side surface 156 of the UAV 100 to provide further customization of the UAV 100.

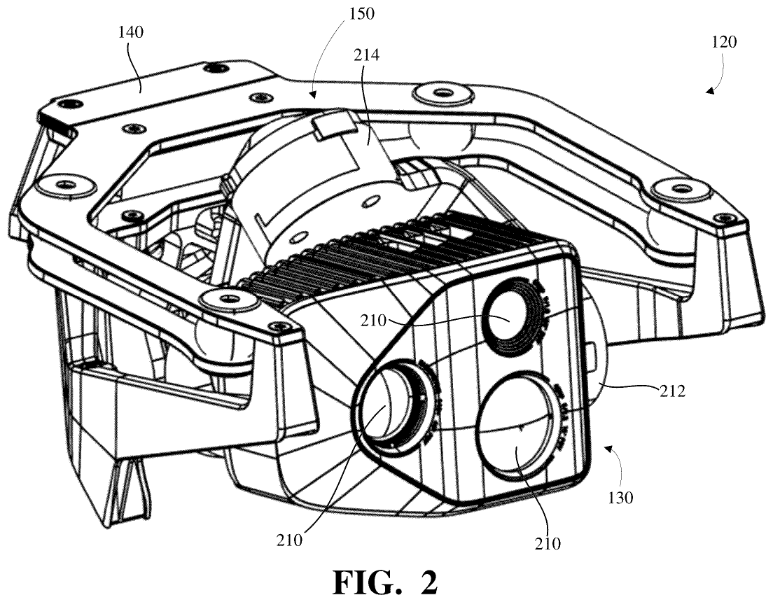

FIG. 2 illustrates a perspective view of the gimbal system 120. As discussed above, the gimbal system may include an image capture device 130 movably coupled to the frame 140 of the gimbal system 120 by the gimbal 150. The frame 140 may be coupled to the UAV 100 in any desired manner, such as by one or more fasteners, one or more mechanical interlocks, or both. However, it is envisioned that the frame 140 may removably couple the gimbal system 120 to the UAV 100 to facilitate easy connection and disconnection of the gimbal system 120 with respect to the UAV 100. Furthermore, the removable coupling of the gimbal system 120 to the UAV 100 may allow for interchangeability between different gimbal systems. By way of example, the gimbal system 120 may be interchanged with an additional gimbal system that includes one or more different attachments, such as a different image capture device (e.g., night-vision camera, infrared camera, etc.) or a different device (e.g., a probe, a light detection and ranging device (LIDAR), etc.). Thus, the gimbal system 120 described herein may allow for easy customization of the UAV 100 depending on the desired operation of the UAV 100.

As discussed above, the image capture device 130 of the gimbal system 120 may be configured to capture images and/or video. The image capture device 130 may include one or more image sensors 210 to capture the images and/or video. By way of example and as shown in FIG. 2, the image capture device 130 may include three image sensors 210. The image sensors 210 may be a wide-angle camera or a narrow-angle camera. A wide-angle camera may be considered a camera having a wider field of view (e.g., a field of view greater than about 90 degrees) while a narrow-angle camera may be considered a camera having a narrow field of view (e.g., a field of view less than about 90 degrees). The image sensors 210 may be a thermal camera (e.g., a radiometric camera or a non-radiometric camera) that may be configured to detect infrared radiation emitted by objects and capture images thereof, which may be processed to create a thermographic image that illustrates thermal patterns and temperature distributes within the environment captured within the image. The image sensors 210 may also be a telephoto camera to facilitate capturing images of distance objects with greater magnification and/or clarity.

The image capture device 130 is not particularly limited to any one type of image sensor, and thus various configurations of the image capture device 130 may be possible based on the teachings herein. By way of example, any combination of the aforementioned camera may be present in the image capture device 130. For example, the image capture device 130 may include a narrow-angled camera, a telephoto camera, and a thermal camera. Alternatively, the image capture device 130 may include a wide-angled camera, a telephoto camera, and a thermal camera. Similarly, the image capture device 130 may include a wide-angled camera, a telephoto camera, and a narrow-angled camera. Moreover, the image capture device 130 may include or be in communication with additional accessories. For example, the image capture device may include a flashlight to illuminate a surrounding area to aid in accurately capturing images of the surround area. Additionally, in certain embodiments, the gimbal system 120 as described herein may be configured to couple other types of devices to the UAV 100, which may be in communication with the image sensors 210 of the image capture device 130.

The gimbal system 120 may movably couple the image capture device 130 to the UAV 100. The gimbal 150 may facilitate movement of the image capture device 130. The gimbal 150 may couple the image capture device 130 to the frame 140, thereby coupling the image capture device 130 to the UAV 100. As shown in FIG. 2, the gimbal 150 may be disposed generally in a central region of the gimbal system 120 that is at least partially surrounded by the frame 140. That is, the frame 140 may define a channel and the gimbal 150 may be partially or entirely disposed in the channel. The gimbal 150 may extend beyond the confines of the frame (e.g., beyond the confines of the channel of the frame 140) before, during, or after operation of the gimbal 150 (e.g., movement of the image capture device 130 and/or movement of the gimbal 150 to maintain a position and/or orientation of the image capture device 130). The frame 140 may be configured to stabilize the gimbal system 120 during operation. For example, the frame 140 may prevent unwanted rattling of the gimbal system 120 with respect to the UAV 100 during movement of the gimbal 150 and the image capture device 130.

The gimbal 150 may include one or more motors that are configured to articulate one or more arms of the gimbal 150. As shown in FIG. 2, the gimbal 150 may include a first motor 212 coupled to the image capture device 130 and a second motor 214 coupled to arms of the gimbal 150. The first motor 212 and the second motor 214 may facilitate substantially free-range movement of the image capture device 130 with respect to the frame 140 free of obstruction from the frame 140 and free of obstruction from the UAV 100. Similarly, the operation of the gimbal 150 may allow for a substantially full range of motion of the image capture device 130 without obstruction of a field of view of the image capture device 130 by the frame 140, the gimbal 150, or the UAV 100. As discussed below, the gimbal 150 may facilitate one or more degrees of freedom of movement of the image capture device 130.

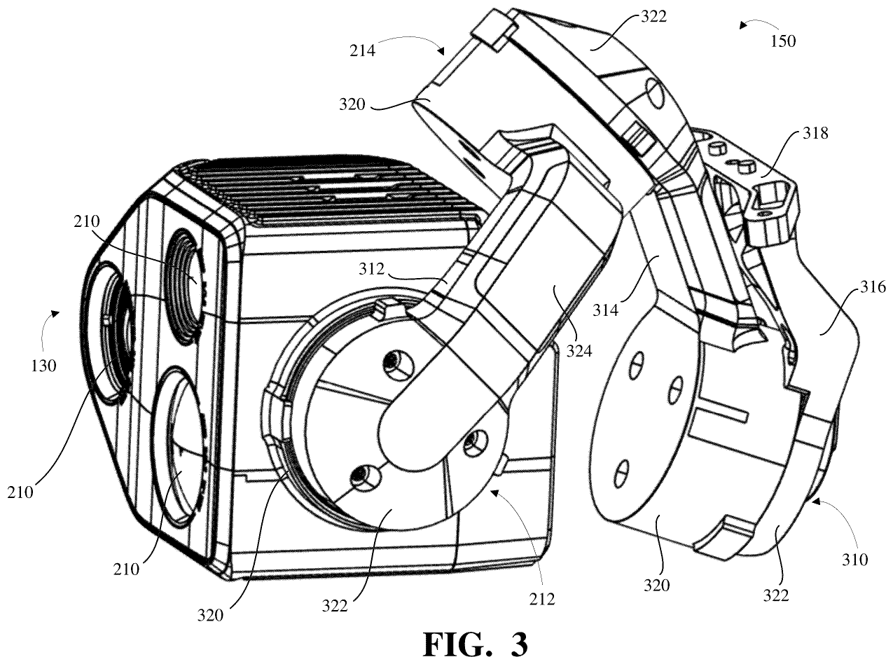

FIG. 3 is a side view of the gimbal system 120. The frame 140 has been omitted from the view for illustrative purposes. However, it should be noted that in certain configurations, the frame 140 may be interchangeable or the gimbal system 120 may be mounted to the UAV without the frame 140.

As discussed above, the gimbal system 120 may include the image capture device 130 movably coupled to the gimbal 150. The gimbal 150 may include the first motor 212 coupled to the image capture device 130, the second motor 214 coupling a first arm 312 of the gimbal 150 to a second arm 314 of the gimbal 150, and a third motor 310 coupling the second arm 314 to a third arm 316 of the gimbal 150. Each of the motors 212, 214, 310 may include a rotor 320 and a stator 322. While the motors 212, 214, 310 may be any type of motor (e.g., AC motor, DC motor, brushless motor, stepped motor, etc.) with any configuration of the rotor 320 and the stator 322, communication between the rotor 320 and the stator 322 may facilitate movement within the gimbal system 120. By way of example, the first motor 212 may function to pitch the image capture device with respect to an axis of rotation of the first motor 212. Similarly, the first arm 312 may be configured to pivot about an axis of rotation of the second motor 214 and the second arm 314 may be configured to pivot about an axis of rotation of the third motor 310. However, depending on the structure and geometry of the arms 312, 314, 316, various articulation envelopes may be possible.

The third arm 316 of the gimbal 150 may also include an attachment portion 318. The attachment portion 318 may be configured to couple the gimbal 150 to the frame 140 of the gimbal system 120. Advantageously, the attachment portion 318 may be easily disconnected from, and connect to, the frame 140 to allow for even further customization, interchangeability, and replacement of various components within the gimbal system 120 (e.g., the image capture device 130, the gimbal 150, etc.). For example, as discussed in further detail below, wiring may be routed through the gimbal 150 (e.g., through the arms 312, 314, 316 of the gimbal 150) to reach each of the motors 212, 214, 310 and the image capture device 130 for operation of the motors 212, 214, 310 and the image capture device 130. Such wiring may also be routed through the frame 140 of the gimbal system 120 in order to connect the wiring of the gimbal system 120 with the UAV 100. The attachment portion 318 of the third arm 316 may allow for connection and disconnection without damaging the wiring of the gimbal system 120 or the UAV 100. Similarly, some or all of the arms 312, 314, 316 may include a cover 324 that permits access to an inner cavity of the arms 312, 314, 316 which may contain the wiring. Thurs, the wiring may be accessed in various locations within the gimbal system 120 to accommodate repairs, installation, replacement, or a combination thereof.

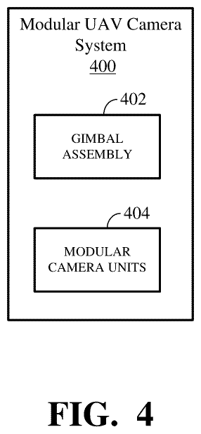

Referring next to FIG. 4, which illustrates a modular UAV camera system 400 including a gimbal assembly 402 and modular camera units 404. The gimbal assembly, referenced as component 402, may serve as the primary support structure for the modular camera units in the UAV camera system. This assembly may incorporate a standardized interface, which may facilitate the mechanical and electrical coupling between the gimbal and the camera units. The standardized interface may include a unified connector, which may provide both mechanical attachment and electrical coupling, thereby enabling seamless integration of the camera units. The gimbal assembly may be configured to incorporate one or more swappable camera modules, allowing for modularity and flexibility in operation. This configuration may enable the camera units to interchangeably attach to the gimbal assembly without requiring reconfiguration or recalibration, thus supporting plug-and-play operation. The gimbal assembly may also include multiple mounting interfaces, which may allow for the simultaneous support of multiple modular camera units, thereby enhancing the system's versatility. The gimbal assembly may be designed to withstand mechanical vibrations and shock loads experienced during UAV flight, ensuring durability and reliability. This capability may be significant for maintaining the structural integrity and imaging performance of the camera units during operation. The gimbal assembly 402, may thus play a pivotal role in the modular UAV camera system by providing a robust and adaptable platform for the integration and operation of various camera modules.

The modular camera units, identified as component 404, may be integral to the UAV camera system, offering a range of imaging capabilities through their interchangeable sub-components. These modular camera units may include an autofocus sub-component, a casing sub-component, and optics and imager sub-components. The autofocus sub-component may enable precise focusing through a micro-motor-driven mechanism, which may include a motor and a translational drive. This mechanism may adjust the focus of the lens sub-module, ensuring that the camera unit can capture clear images. The casing sub-component may provide environmental protection and uniformity in dimensions, potentially acting as an environmentally sealed enclosure that meets at least an IP54 ingress protection rating. This may protect the internal components, such as the autofocus, lens, and sensor sub-modules, from dust and water spray. The optics and imager sub-components may offer versatility in imaging capabilities, allowing for different optical properties or spectral wavebands. These sub-components may conform to uniform mechanical and electrical interfaces, ensuring compatibility and standardization across the modular camera units. The modular camera units may be configured to interchangeably attach to the gimbal assembly via a standardized interface, facilitating plug-and-play operation without the need for reconfiguration or recalibration. This standardized interface may include a unified connector providing both mechanical attachment and electrical coupling, which may carry power and data signals through a standardized pinout. The modular camera units may also be configured to withstand mechanical vibrations and shock loads experienced during UAV flight, maintaining imaging performance and structural integrity. The modularity and flexibility of these camera units may allow for easy swapping and customization, enabling the UAV system to adapt to various imaging requirements.

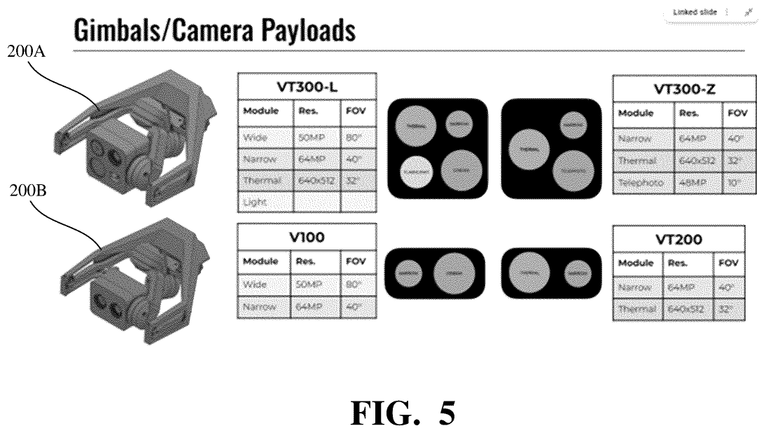

Referring to FIG. 5, several embodiments of the modular UAV camera system are shown. The figure depicts different gimbal assemblies, such as a first gimbal assembly 200A and a second gimbal assembly 200B, each configured to support one or more modular camera units. The accompanying tables illustrate various camera payload configurations, such as VT300-L (210), V100 (220), VT300-Z (230), and VT200 (240). These tables demonstrate the interchangeability of different camera modules (e.g., Wide, Narrow, Thermal) to achieve different imaging capabilities, defined by resolution (Res.) and field of view (FOV), on a standardized gimbal platform.

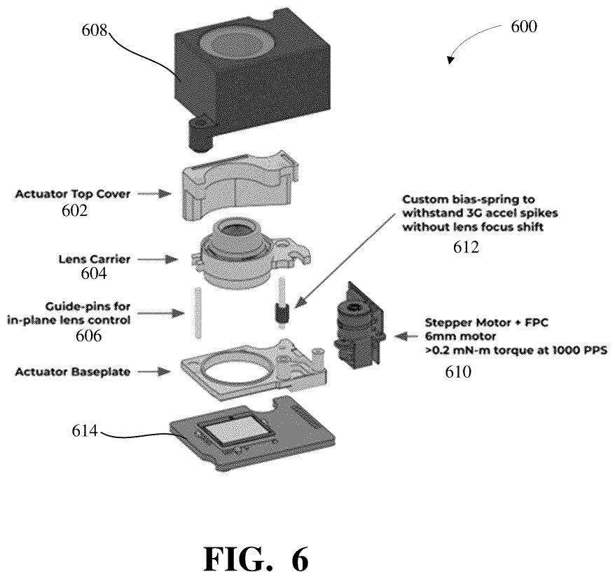

FIG. 6 illustrates an exploded view 600 illustrating the components of a standardized autofocus actuator sub-module 600, in accordance with various embodiments. This sub-module is a self-contained unit designed for interchangeable use across different camera modules. The sub-module 600 comprises a module housing formed by an actuator top cover 602 and an actuator baseplate 608. Within the housing, a motor drive unit, specifically a stepper motor 610, drives a translation mechanism. The translation mechanism includes a lens carrier 604, which is guided by guide-pins 606 for precise in-plane control. A bias-spring 612 is included to maintain tension and prevent focus shift due to acceleration. The baseplate 608 is configured to mount onto other components, such as a sensor sub-module on a printed circuit board 614.

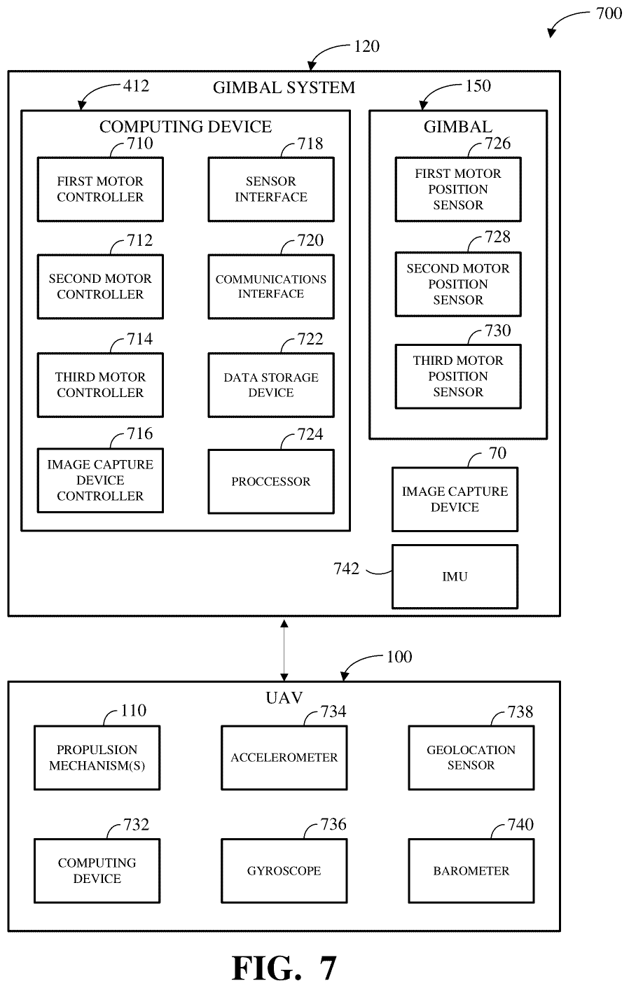

FIG. 7 illustrates a block diagram 700 of an example of a hardware configuration of the gimbal system 120 removably coupled to the UAV 100. The hardware configuration of the gimbal system 120 may be connected or in communication with UAV 100 and a hardware configuration thereof. The gimbal system 120 may include a computing device 412, the image capture device 130, and the gimbal 150 as described above. The computing device 412 of the gimbal system 120 may include a first motor controller 710, a second motor controller 712, a third motor controller 714, an image capture device controller 716, a sensor interface 718, a communication interface 720, a data storage device 722, and a processor 724.

The computing device 412 may be operable to execute instructions that have been stored in the data storage device 722 or elsewhere. The computing device 412 may be a processor with random access memory (RAM) for temporarily storing instructions read from the data storage device 722 or elsewhere while the instructions are being executed. The computing device 412 may include a single processor (e.g., the processor 724) or multiple processors each having single or multiple processing cores. Alternatively, the computing device 412 may include another type of device, or multiple devices, capable of manipulating or processing data (e.g., a processing apparatus). For example, all or some of the above operations of the computing device 412 may be done by the processor 724 or one or more additional processors of the computing device 412. The computing device 412 may be arranged into a processing unit, such as a central processing unit (CPU) or a graphics process unit (GPU).

The data storage device 722 may be a non-volatile information storage device, for example, a solid-state drive, a read-only memory device (ROM), an optical disc, a magnetic disc, or another suitable type of storage device such as a non-transitory computer readable memory. The data storage device 722 may include another type of device, or multiple devices, capable of storing data for retrieval or processing by the computing device 412 or the processor 724 thereof. The computing device 412 may access and manipulate data stored in the data storage device 722 (e.g., through an interconnect of the computing device 412, such as a bus or a wired or wireless network (e.g., a vehicle area network).

The sensor interface 718 may be configured to control and/or receive data from one or more sensors of the gimbal system 120. For example, the sensor interface 718 may be configured to control and/or receive data from a first motor position sensor 726 of the first motor 212, a second motor position sensor 728 of the second motor 214, and a third motor position sensor 730 of the third motor 310. The motor position sensors 726, 728, 730 may be position sensor(s) 810 discussed above.

The sensor interface 718 may also control and/or receive data from one or more sensors of the UAV 100. The sensor interface 718 may control and/or receive data from an accelerometer 734, a geolocation sensor 738, a gyroscope 736, a barometer 740, or a combination thereof of the UAV 100. All or some of the sensors of the UAV 100 may form the IMU of the UAV 100 discussed above. In some implementations, the accelerometer 734 and the gyroscope 736 may be combined as the inertial measurement unit (IMU).

The data controlled and/or received by the sensor interface 718 may refer, for example, to one or more of temperature measurements, pressure measurements, a global positioning system (GPS) data, acceleration measurements, angular rate measurements, magnetic flux measurements, a visible spectrum image, an infrared image, an image including infrared data and visible spectrum data, and/or other sensor output. For example, the motor position sensors 726, 728, 730 may generate data pertaining to a position of the motors 212, 214, 310 of the gimbal 150. In some implementations, the sensor interface 718 may implement a serial port protocol (e.g., I2C or SPI) for communications with one or more sensor devices over conductors. In some implementations, the sensor interface 718 may include a wireless interface for communicating with one or more sensor groups via low-power, short-range communications techniques (e.g., using a vehicle area network protocol).

The communications interface 720 may facilitate communication with one or more other devices, for example, the UAV 100 or a system thereof, a controller (e.g., a first motor controller 710, a second motor controller 712, a third motor controller 714, an image capture device controller 716, or a combination thereof), or another device, for example, the user interface 930 (e.g., a smartphone, tablet, or other device). The controllers in communication with the communication interface 720 may be configured to control operation of the motors 212, 214, 310 and the image capture device 70. The communications interface 720 may include a wireless interface and/or a wired interface. For example, the wireless interface may facilitate communication via a Wi-Fi network, a Bluetooth link, a ZigBee link, or another network or link. In another example, the wired interface may facilitate communication via a serial port (e.g., RS-232 or USB). The communications interface 720 may further facilitate communication via a network, which may, for example, be the Internet, a local area network, a wide area network, or another public or private network. Thus, the communications interface 720 may be used to control operation of the motors 212, 214, 310 and the image capture device 70.

As discussed above, by way of example, the data storage device 722 may be configured to store calibration data of the gimbal system 120. The communications interface 720 may be configured to transmit the calibration data of the gimbal system 120 to the UAV 100. The communications interface 720 may transmit the calibration data to a computing device 732 of the UAV 100, whereby the computing device 732 may adjust flight characteristics of the UAV 100 based upon the calibration data. For example, the computing device 732 of the UAV 100 may include a communications interface that may control the propulsion mechanism(s) based on the calibration data transmitted from the gimbal system 120. The data storage device 722 may be configured to store calibration data specific to the gimbal system 120 and may dynamically update the calibration data based upon operation of the gimbal system 120 (e.g., through data provided by the motor position sensors 726, 728, 730).

To further illustrate communication between the gimbal system 120 and the UAV 100, initializing the gimbal system 120 will now be discussed in further detail. That is, when the gimbal system 120 is coupled to the UAV 100 (e.g., electrically and/or mechanically coupled to the UAV 100), the gimbal system 120 and/or the UAV 100 may complete an initialization process to prepare the gimbal system 120 and the UAV 100 for operation (e.g., flight and/or movement or use of the gimbal system 120).

Initialization of the gimbal system 120 and the UAV 100 may include calibrating the gimbal system 120 as described above with respect to ensure that the gimbal system 120 properly operates once connected to the UAV 100. Additionally, the UAV 100 may also be calibrated during initialization based on the calibration data stored on a computing device 412 of the gimbal system 120 being communicated to the UAV 100 (e.g., communicated to the computing device 732 of the UAV 100) to modify or otherwise adjust flight characteristics and/or propulsion characteristics of the UAV 100.

Data (e.g., measurements) obtained by one or more of the components of the UAV 100 and/or one or more components of the gimbal system 120 may be utilized to initialize the gimbal system 120 and/or the UAV 100. For example, the gimbal system 120 may include an inertial measurement unit (IMU) 742 that may be configured to measure and/or track a specific force, angular rate, magnetic field, or other parameters of the gimbal system 120. The IMU 742 may include one or more components that are similar to the componentry of the UAV 100. That is, the UAV 100 may also include an IMU that is separate from the IMU 742, which may include the accelerometer 734, the gyroscope 736, the barometer 740, other sensors, or a combination thereof. As such the components of the shown in FIG. 7 UAV 100 may track or measure operation and/or positioning of the UAV 100 while the IMU 742 and/or other components of the gimbal system 120 (e.g., the first motor position sensor 726, the second motor position sensor 728, and the third motor position sensor 730) may track or measure operation and/or positioning of the gimbal system 120. That is, the various measurements obtained by the gimbal system 120 and the UAV 100 may be utilized to initialize the gimbal system 120 and the UAV 100 to ensure proper operation thereafter.

To further illustrate, an example of initializing the gimbal system 120 will now be described. To initialize the gimbal system 120, data (e.g. measurements) obtained by the IMU 742 of the gimbal system 120 and/or an IMU of the UAV 100 (e.g., the accelerometer 734 and the gyroscope 736) may be analyzed to determine a position of the gimbal system 120. For example, the IMU 742 may provide accelerometer readings for the gimbal system 120 and the IMU of the UAV 100 may provide accelerometer readings for the UAV 100. Based on such data, a direction of gravity may be determined (e.g., determined by the computing device 412 of the gimbal system 120 and/or the computing device 732 of the UAV 100), which may then be utilized to determine an altitude of the UAV 100. As the direction of gravity may only be a two degree of freedom measurement, full rotation (e.g., three degrees of freedom) may not yet be constrained without additional data.

Due to a high range of motion of the first motor 212, the second motor 214, and the third motor 310, a yaw axis may also need to be determined or otherwise accounted for to determine a full rotational position of the gimbal system 120 (i.e., a position of the image capture device 70 with three degrees of freedom), whereby the yaw axis may correspond to the elevational axis (Z) shown in FIG. 1. Data (e.g., measurements) obtained by the first motor position sensor 726, the second motor position sensor 728, and the third motor position sensor 730 may be utilized to determine the yaw axis and further isolate positioning of the gimbal system 120 (e.g., positioning of the image capture device 70).

By way of example, as discussed above, the first motor position sensor 726, the second motor position sensor 728, and the third motor position sensor 730 may each be or include a Hall effect sensor, whereby each of the sensors may determine an angle of each motor with respect to an axis of rotation of the motor (e.g., an angle of rotation of the first motor 212 with respect to the first axis of rotation (A), an angle of rotation of the second motor 214 with respect to the second axis of rotation (B), and an angle of rotation of the third motor 310 with respect to the third axis of rotation (C)). Such angles may determine a rotational position of the rotor of each motor with respect to their respective axis of rotation. However, due to such rotational positions being relative to a specific motor and potentially being based upon a finite number of possible angles (e.g., angles potentially detected by the position sensors based upon the number of magnets within the rotor of a given motor), positioning of rotational hard stops within each motor (e.g., the end stops 712) may also be implemented to more accurately determine the positions of each motor.

The rotational positions of each motor as described above may be used in conjunction with the measurements obtained by the IMU 742 of the gimbal system 120 and/or the IMU of the UAV 100. Similarly, measurements from the IMU 742 of the gimbal system 120 and/or the IMU of the UAV 100 may be utilized to initialize each of the position sensors (i.e., each of the motors) such that the position sensors may more accurately determine the position of each motor.

By way of example, readings from one or more of the position sensors may be combined to determine all possible positions (i.e., solutions) of a given motor. Each motor may have a certain number of possible positions based upon a configuration of the rotor of the motor (e.g., number of magnets within the rotor). Based on all possible positions, it may be determined (e.g., via the processor 724) that one or more of the possible positions is in fact impossible based upon the true range of motion of a particular motor, which may be based on predefined parameters of the motor and/or based upon relative positioning of each of the motors that may constrain certain movements of a given motor.

Once the impossible positions are discarded from the analysis, each position (i.e., solution) may be evaluated to determine whether such a position may align with the current data (e.g., measurements) obtained by the IMU 742 of the gimbal system 120 and/or the IMU of the UAV 100, which may be considered IMU readings. If a position aligns with the IMU readings, then it may be determined to be the correct (i.e., actual) position of the gimbal system 120. As such, the determined position may then be used as an initial starting position of the gimbal system 120 to begin calibrating the gimbal system 120 and/or to begin operation of the gimbal system 120.

However, due to variation in any particular gimbal system, further evaluation may be completed to increase the confidence in a determined position. By way of example, in certain configurations the yaw axis may be aligned perpendicular to the direction of gravity determined above. Based on such a position, it may not be possible to determine the motor angle with respect to the yaw axis. To further evaluate, the possible correct positions of the gimbal system 120 may be propagated using IMU data, such as measurements from the gyroscope 736 of the UAV 100 and/or measurements from a gyroscope of the IMU 742 of the gimbal system 120. This may help predict how such positions may change over time during operation of the UAV 100 and/or operation of the gimbal system 120. During such propagations, the possible correct positions may be analyzed to evaluate whether each of the positions is viable. Based on such evaluation, the correct position (i.e., the actual position) may be determined due to its significantly higher viability when compared to the remaining possible positions. As such, a significantly higher level of confidence with respect to the determined correct position may be achieved. Additionally, to avoid any further ambiguity, one or more of the motors may be rotated during this evaluation to ensure that one or more of the possible movements of the gimbal system 120 are not aligned (e.g., yaw and pitch axes aligned).

Once the position of each of the motors is determined based on the above, this information may be provided to the gimbal system 120 to begin calibration and/or operation. That is, the initializing process may accurately determine the position of each of the motors within the gimbal system 120 such that an initial starting position of the gimbal system 120 and thus the image capture device 70 may be determined. Similarly, the accurate determination of the position of each of the motors may also provide the user a finer control of movement of the gimbal system 120 when operating the gimbal system 120. That is, the user may articulate each of the arms of the gimbal system 120 more accurately based upon finer possible movement of each of the motors.

To further illustrate the above example of initializing, the present teachings may provide a method of initializing the gimbal system 120 of the UAV 100 to determine the initial position of the image capture device 70 coupled to the gimbal 150 of the gimbal system 120. The method may include obtaining, via the IMU 742 of the gimbal system 120, measurements of one or more parameters of the gimbal system 120. The method may also include determining, based upon a measurement obtained by a position sensor (e.g., the first motor position 726, the second motor position sensor 728, or the third motor position sensor 730) of the gimbal system 120, a rotational position of a motor (e.g., the first motor 212, the second motor 214, or the third motor 310) of the gimbal 150 with respect to an axis of rotation of the motor. Additionally, the method may include determining a possible position of the image capture device 130 based upon the rotational position of the motor and the one or more parameters. Responsive to determining the possible position, the method may also include determining whether the possible position is the initial position by comparing the possible position to the measurements, as described above.

### Additional Embodiments

In some implementations, a modular unmanned aerial vehicle (UAV) camera system is described. The modular UAV comprises: a gimbal assembly configured to incorporate one or more swappable camera modules; a plurality of modular camera units configured to interchangeably attach to the gimbal assembly via a standardized interface, each modular camera unit comprising a plurality of self-contained sub-components including an autofocus sub-component and a casing sub-component; and wherein the autofocus sub-component and the casing sub-component conform to uniform mechanical and electrical interfaces across the plurality of modular camera units, enabling the modular camera units to be exchanged on the gimbal assembly to provide different imaging capabilities.

In some implementations, wherein the plurality of self-contained sub-components of each modular camera unit further includes an optics sub-component and an imager sub-component, the optics sub-component and the imager sub-component conforming to the uniform mechanical and electrical interfaces.

In some implementations, wherein the optics sub-component and the imager sub-component vary across the plurality of modular camera units to provide the different imaging capabilities.

In some implementations, wherein the casing sub-component is an environmentally sealed enclosure providing ingress protection for the plurality of self-contained sub-components.

In some implementations, the modular UAV camera system of claim 1, wherein the standardized interface includes a unified connector providing both mechanical attachment and electrical coupling between the gimbal assembly and each modular camera unit.

In some implementations, the modular UAV camera system of claim 5, wherein the unified connector carries power and data signals through a standardized pinout.

In some implementations, the modular UAV camera system of claim 1, wherein exchanging the modular camera units on the gimbal assembly is performed without reconfiguration or recalibration, enabling plug-and-play operation.

In some implementations, the modular UAV camera system of claim 1, wherein the autofocus sub-component comprises a micro-motor-driven focus mechanism including a motor and a translational drive.

In some implementations, the modular UAV camera system of claim 1, wherein the casing sub-component of each modular camera unit has substantially identical dimensions and mounting features for attachment to the gimbal assembly.

In some implementations, the modular UAV camera system of claim 1, wherein the gimbal assembly includes a plurality of mounting interfaces for simultaneously supporting multiple modular camera units.

In some implementations, the modular UAV camera system of claim 1, wherein each modular camera unit is configured to withstand mechanical vibrations and shock loads experienced during UAV flight.

In some implementations, a modular camera unit for an unmanned aerial vehicle (UAV) gimbal assembly is described. The modular camera unit comprises: a casing sub-component defining a standardized form factor and including a gimbal interface for mechanical and electrical coupling; an autofocus sub-component mounted within the casing sub-component; and a plurality of additional sub-components contained within the casing sub-component, the plurality of additional sub-components including an optics sub-component and an imager sub-component; wherein the autofocus sub-component, the casing sub-component, and the gimbal interface are standardized across a plurality of modular camera units, and the optics sub-component and the imager sub-component are interchangeable to configure the modular camera unit for different imaging capabilities.

In some implementations, wherein the casing sub-component encloses and environmentally seals the autofocus sub-component and the plurality of additional sub-components.

In some implementations, wherein the casing sub-component includes a standardized mounting footprint and attachment mechanism for mating with the UAV gimbal assembly.

In some implementations, wherein the gimbal interface comprises a standardized multi-pin electrical connector for delivering power, control signals, and data between the modular camera unit and the UAV gimbal assembly.

In some implementations, wherein the autofocus sub-component, the optics sub-component, and the imager sub-component are individually removable and replaceable within the casing sub-component.

In some implementations, wherein the imager sub-component comprises an imaging sensor having a resolution of at least 12 megapixels.

In some implementations, wherein the optics sub-component and the imager sub-component are interchangeable with other optics sub-components and imager sub-components having different optical properties or spectral wavebands.

In some implementations, wherein the autofocus sub-component comprises a micro-motor-driven focus mechanism including a motor and a translational drive configured to adjust focus of the optics sub-component.

In some implementations, wherein the modular camera unit is configured to withstand mechanical vibrations and shock loads up to 20 g experienced during UAV flight without loss of imaging performance or structural integrity.

In some implementations, a UAV (unmanned aerial vehicle) imaging system is disclosed (claim 21). The UAV imaging system comprising: a gimbal assembly having a mounting interface; a first camera module removably attached to the gimbal assembly via the mounting interface; and a second camera module interchangeable with the first camera module on the gimbal assembly; wherein each of the first and second camera modules comprises a plurality of individually packaged sub-modules including at least an autofocus actuator sub-module, a lens sub-module, a sensor sub-module, and a housing sub-module, each of the sub-modules having standardized mechanical and electrical interfaces such that the autofocus actuator sub-module and the housing sub-module of the first camera module are identical to those of the second camera module, and the first and second camera modules differ only in one or more of the lens sub-module or the sensor sub-module to provide different imaging capabilities.

In some implementations, wherein each camera module's housing sub-module is an environmentally sealed enclosure meeting at least an IP54 ingress protection rating to protect the lens, sensor, and autofocus sub-modules from dust and water spray.

In some implementations, wherein the gimbal assembly and camera modules include a unified connector interface providing both mechanical attachment and electrical coupling, the unified connector carrying power and data signals between the gimbal and the camera module through a standardized pinout.

In some implementations, wherein swapping camera modules does not require any reconfiguration or recalibration of the gimbal assembly or the UAV's control system, such that the second camera module operates plug-and-play on the gimbal after removal of the first camera module.

In some implementations, wherein the autofocus actuator sub-module in each camera module comprises a micro-motor-driven focus mechanism with identical components across the first and second camera modules, the focus mechanism including a motor and a translational drive configured to adjust focus of the lens sub-module.

In some implementations, wherein the outer housing sub-modules of the first and second camera modules have identical dimensions and mounting features, so that both camera modules present the same form-factor and attachment points to the gimbal assembly.

In some implementations, wherein the gimbal assembly includes multiple mounting interfaces configured to support a plurality of camera modules simultaneously, each of the plurality of camera modules being constructed from said standardized sub-modules and presenting the same attachment interface to the gimbal.

In some implementations, wherein each camera module is configured to withstand mechanical vibrations and shock experienced during UAV flight, including shock loads up to 10 g, without loss of imaging performance or structural integrity of the sub-modules.

In some implementations, a modular camera module for a UAV gimbal is disclosed. The modular camera module for the UAV gimbal, comprising: an outer housing sub-module defining a standardized form factor; an autofocus actuator sub-module mounted within the housing; a lens sub-module operatively coupled to the autofocus actuator sub-module; a sensor sub-module aligned with the lens sub-module to capture images; and a gimbal interface on the housing for power and data connection; wherein each of the autofocus actuator sub-module, lens sub-module, sensor sub-module, and housing sub-module is a self-contained unit with predefined mechanical and electrical interfaces, such that the autofocus actuator sub-module, housing sub-module, and gimbal interface are reusable across different camera modules, and only the lens sub-module or sensor sub-module is substituted to configure the camera module for different optical or spectral imaging roles.

In some implementations, wherein the housing sub-module encloses and seals the internal sub-modules with gaskets or seals to provide environmental resistance at least equivalent to an IP54 rating, thereby protecting the autofocus, lens, and sensor sub-modules from dust and moisture.

In some implementations, wherein the outer housing sub-module includes a standardized mounting footprint and attachment mechanism to mate with the UAV gimbal's interface, such that the camera module can be attached or detached using common fasteners or latches in a consistent manner.

In some implementations, wherein the camera module comprises a standardized multi-pin electrical connector as the gimbal interface, the connector being common to all camera modules for delivering power, control signals, and data between the camera module and the UAV.

In some implementations, wherein the autofocus actuator sub-module, lens sub-module, and sensor sub-module are each removably secured within the housing sub-module via predefined attachment points, allowing individual sub-modules to be replaced or upgraded without changing the overall housing or interface.

In some implementations, wherein the sensor sub-module comprises an imaging sensor having a resolution of at least 12 megapixels, the sensor sub-module being interchangeable with other sensor sub-modules of different resolutions or wavebands while maintaining compatibility with the autofocus actuator and housing sub-modules.

In some implementations, wherein the camera module is configured for hot-swap deployment on the UAV gimbal without requiring firmware or calibration changes, such that the module can be mounted to or dismounted from the gimbal and made operational immediately using pre-calibrated internal settings.

In some implementations, a method of configuring a UAV gimbal with interchangeable camera modules is disclosed. The UAV gimbal with interchangeable camera modules comprising: attaching a first camera module to a gimbal assembly on the UAV, the first camera module comprising a standardized set of sub-modules including a focus actuator, a lens assembly, and an image sensor; removing the first camera module from the gimbal assembly when a different imaging function is desired; attaching a second camera module to the gimbal assembly in place of the first camera module, the second camera module having a different lens assembly or image sensor but sharing at least one identical sub-module with the first camera module; and operating the UAV with the second camera module without making any hardware or software modifications to the gimbal, whereby the standardized interfaces of the camera modules enable plug-and-play interchangeability.

In some implementations, wherein no alignment or recalibration steps are performed after attaching the second camera module, the gimbal and UAV control system recognizing and accommodating the new module automatically due to the common interface and self-contained calibration of the module.

In some implementations, wherein attaching the second camera module is performed without powering down the UAV or the gimbal assembly, thereby allowing hot-swapping of camera modules in the field.

In some implementations, further comprising automatically detecting an identity or type of the second camera module via the standardized electrical interface and applying appropriate operational settings for that module upon attachment.

In some implementations, wherein identical focus control parameters and algorithms are used for the first and second camera modules by the UAV's control system, as a result of both modules incorporating the same autofocus actuator sub-module with uniform performance characteristics.

In some implementations, wherein the first camera module is a visible-light camera module and the second camera module is a thermal infrared camera module, and the gimbal assembly accommodates the swap between the visible-light and thermal camera modules without any change in mounting hardware or interface configuration.

In some implementations, an autofocus actuator module for a modular UAV camera system is disclosed. The actuator module for a modular UAV camera the autofocus actuator module being a self-contained focusing unit configured for interchangeable use in a plurality of different camera modules, wherein the autofocus actuator module comprises: a motor drive unit; a translation mechanism driven by the motor drive unit and configured to move a lens element along an optical axis for focusing; a module housing enclosing the motor drive unit and translation mechanism; and a standardized interface portion on the module housing for coupling to other sub-modules and to a camera module housing; such that the autofocus actuator module can be integrated into different camera modules that require lens focusing, without modification to the actuator module's internal components.

In some implementations, wherein the motor drive unit comprises a micro-stepper motor coupled to a lead screw as the translation mechanism, the lead screw engaging a lens carriage to adjust the focus position of the lens element.

In some implementations, wherein the module housing incorporates linear guide rails or bearings to stabilize the lens carriage and a preload spring biasing the carriage to eliminate backlash in the focus mechanism.

In some implementations, wherein the translation mechanism provides a focus travel range of at least 5 mm along the optical axis, allowing the actuator to accommodate lenses with a wide range of focal depths.

In some implementations, wherein the module is configured to withstand vibrations and shock associated with UAV operation, including shock loads up to approximately 10 g, such that the focus performance remains reliable under flight-induced movements.

In some implementations, wherein the module housing is substantially sealed to prevent dust or debris from contaminating the motor or translation mechanism, thereby ensuring long-term reliability of the focusing assembly.

In some implementations, wherein the standardized interface portion includes a mechanical mounting flange compatible with a lens sub-module and alignment features to ensure correct optical positioning when the lens sub-module is attached.

In some implementations, wherein the standardized interface portion further includes an electrical connector for supplying power and control signals to the motor drive unit and for communicating any feedback or status signals from the actuator module to the camera module's electronics.

In some implementations, further comprising a position sensor associated with the translation mechanism to detect the position of the lens carriage, enabling closed-loop autofocus control and providing consistent focus calibration across different camera modules using the actuator module.

While the disclosure has been described in connection with certain embodiments, it is to be understood that the disclosure is not to be limited to the disclosed embodiments but, on the contrary, is intended to cover various modifications and equivalent arrangements included within the scope of the appended claims, which scope is to be accorded the broadest interpretation so as to encompass all such modifications and equivalent structures as is permitted under the law.

Persons skilled in the art will understand that the various embodiments of the present disclosure and shown in the accompanying figures constitute non-limiting examples, and that additional components and features may be added to any of the embodiments discussed hereinabove without departing from the scope of the present disclosure. Additionally, persons skilled in the art will understand that the elements and features shown or described in connection with one embodiment may be combined with those of another embodiment without departing from the scope of the present disclosure to achieve any desired result and will appreciate further features and advantages of the presently disclosed subject matter based on the description provided. Variations, combinations, and/or modifications to any of the embodiments and/or features of the embodiments described herein that are within the abilities of a person having ordinary skill in the art are also within the scope of the present disclosure, as are alternative embodiments that may result from combining, integrating, and/or omitting features from any of the disclosed embodiments.

Use of the term “optionally” with respect to any element of a claim means that the element may be included or omitted, with both alternatives being within the scope of the claim. Additionally, use of broader terms such as “comprises,” “includes,” and “having” should be understood to provide support for narrower terms such as “consisting of,” “consisting essentially of,” and “comprised substantially of. ” Accordingly, the scope of protection is not limited by the description set out above, but is defined by the claims that follow, and includes all equivalents of the subject matter of the claims.

In the preceding description, reference may be made to the spatial relationship between the various structures illustrated in the accompanying drawings, and to the spatial orientation of the structures. However, as will be recognized by those skilled in the art after a complete reading of this disclosure, the structures described herein may be positioned and oriented in any manner suitable for their intended purpose. Thus, the use of terms such as “above,” “below,” “upper,” “lower,” “inner,” “outer,” “left,” “right,” “upward,” “downward,” “inward,” “outward,” “horizontal,” “vertical,” etc., should be understood to describe a relative relationship between the structures and/or a spatial orientation of the structures. Those skilled in the art will also recognize that the use of such terms may be provided in the context of the illustrations provided by the corresponding figure(s).

Additionally, terms such as “approximately,” “generally,” “substantially,” and the like should be understood to allow for variations in any numerical range or concept with which they are associated and encompass variations on the order of 25% (e.g., to allow for manufacturing tolerances and/or deviations in design). For example, the term “generally parallel” should be understood as referring to configurations in with the pertinent components are oriented so as to define an angle therebetween that is equal to 180°±25% (e.g., an angle that lies within the range of (approximately) 135° to (approximately) 225°). The term “generally parallel” should thus be understood as referring to encompass configurations in which the pertinent components are arranged in parallel relation.

Although terms such as “first,” “second,” “third,” etc., may be used herein to describe various operations, elements, components, regions, and/or sections, these operations, elements, components, regions, and/or sections should not be limited by the use of these terms in that these terms are used to distinguish one operation, element, component, region, or section from another. Thus, unless expressly stated otherwise, a first operation, element, component, region, or section could be termed a second operation, element, component, region, or section without departing from the scope of the present disclosure.

As used herein, unless specifically stated otherwise, the term “or” encompasses all possible combinations, except where infeasible. For example, if it is stated that a component includes A or B, then, unless specifically stated otherwise or infeasible, the component may include only A, or only B, or A and B. As a second example, if it is stated that a component includes A, B, or C, then, unless specifically stated otherwise or infeasible, the component may include only A, or only B, or only C, or A and B, or A and C, or B and C, or A and B and C. Expressions such as “at least one of” do not necessarily modify an entirety of a following list and do not necessarily modify each member of the list, such that “at least one of A, B, and C” should be understood as including only A, or only B, or only C, or any combination of A, B, and C. The phrase “one of A and B” or “any one of A and B”shall be interpreted in the broadest sense to include one of A, or one of B.

The descriptions herein are intended to be illustrative, not limiting. Thus, it will be apparent to one skilled in the art that modifications may be made as described without departing from the scope of the claims set out below.

What is claimed is:

1. A modular unmanned aerial vehicle (UAV) camera system, comprising:
a gimbal assembly configured to incorporate one or more swappable camera modules;
a plurality of modular camera units configured to interchangeably attach to the gimbal assembly via a standardized interface, each modular camera unit comprising a plurality of self-contained sub-components including an autofocus sub-component and a casing sub-component; and
wherein the autofocus sub-component and the casing sub-component conform to uniform mechanical and electrical interfaces across the plurality of modular camera units, enabling the modular camera units to be exchanged on the gimbal assembly to provide different imaging capabilities.

2. The modular UAV camera system of claim 1, wherein the plurality of self-contained sub-components of each modular camera unit further includes an optics sub-component and an imager sub-component, the optics sub-component and the imager sub-component conforming to the uniform mechanical and electrical interfaces.

3. The modular UAV camera system of claim 2, wherein the optics sub-component and the imager sub-component vary across the plurality of modular camera units to provide the different imaging capabilities.

4. The modular UAV camera system of claim 1, wherein the casing sub-component is an environmentally sealed enclosure providing ingress protection for the plurality of self-contained sub-components.

5. The modular UAV camera system of claim 1, wherein the standardized interface includes a unified connector providing both mechanical attachment and electrical coupling between the gimbal assembly and each modular camera unit.

6. The modular UAV camera system of claim 5, wherein the unified connector carries power and data signals through a standardized pinout.

7. The modular UAV camera system of claim 1, wherein exchanging the modular camera units on the gimbal assembly is performed without reconfiguration or recalibration, enabling plug-and-play operation.

8. The modular UAV camera system of claim 1, wherein the autofocus sub-component comprises a micro-motor-driven focus mechanism including a motor and a translational drive.

9. The modular UAV camera system of claim 1, wherein the casing sub-component of each modular camera unit has substantially identical dimensions and mounting features for attachment to the gimbal assembly.

10. The modular UAV camera system of claim 1, wherein the gimbal assembly includes a plurality of mounting interfaces for simultaneously supporting multiple modular camera units.

11. The modular UAV camera system of claim 1, wherein each modular camera unit is configured to withstand mechanical vibrations and shock loads experienced during UAV flight.

12. A modular camera unit for an unmanned aerial vehicle (UAV) gimbal assembly, the modular camera unit comprising:
a casing sub-component defining a standardized form factor and including a gimbal interface for mechanical and electrical coupling;
an autofocus sub-component mounted within the casing sub-component; and
a plurality of additional sub-components contained within the casing sub-component, the plurality of additional sub-components including an optics sub-component and an imager sub-component;
wherein the autofocus sub-component, the casing sub-component, and the gimbal interface are standardized across a plurality of modular camera units, and the optics sub-component and the imager sub-component are interchangeable to configure the modular camera unit for different imaging capabilities.

13. The modular camera unit of claim 12, wherein the casing sub-component encloses and environmentally seals the autofocus sub-component and the plurality of additional sub-components.

14. The modular camera unit of claim 12, wherein the casing sub-component includes a standardized mounting footprint and attachment mechanism for mating with the UAV gimbal assembly.

15. The modular camera unit of claim 12, wherein the gimbal interface comprises a standardized multi-pin electrical connector for delivering power, control signals, and data between the modular camera unit and the UAV gimbal assembly.

16. The modular camera unit of claim 12, wherein the autofocus sub-component, the optics sub-component, and the imager sub-component are individually removable and replaceable within the casing sub-component.

17. The modular camera unit of claim 12, wherein the imager sub-component comprises an imaging sensor having a resolution of at least 12 megapixels.

18. The modular camera unit of claim 12, wherein the optics sub-component and the imager sub-component are interchangeable with other optics sub-components and imager sub-components having different optical properties or spectral wavebands.

19. The modular camera unit of claim 12, wherein the autofocus sub-component comprises a micro-motor-driven focus mechanism including a motor and a translational drive configured to adjust focus of the optics sub-component.

20. The modular camera unit of claim 12, wherein the modular camera unit is configured to withstand mechanical vibrations and shock loads up to 2g experienced during UAV flight without loss of imaging performance or structural integrity.
